(19) United States
(12) Patent Application Publication
(10) Pub. No.: US 2012/0205018 A1
(43) Pub. Date: Aug. 16, 2012

(54) SPIKE HOLDER AND METHOD FOR THE PRODUCTION THEREOF

(75) Inventors: Stefan Roth, Aichhalden (DE); Rainer Krahl, Aichhalden (DE); Claus Totzki, Schramberg (DE)

(73) Assignee: Sitek-Spikes GmbH & Co.. KG

(21) Appl. No.: 13/262,244

(22) PCT Filed: Mar. 10, 2010
(86) PCT No.: PCT/EP10/53027

§ 371 Date: Mar. 15, 2012

(30) Foreign Application Priority Data
Apr. 3, 2009 (DE) 10 2009 016 065.5

(51) Int. Cl. B60C 27/00; B22D 25/02; B22D 19/00

(52) U.S. Cl. 152/208; 164/98; 164/76.1

(57) ABSTRACT

The invention relates to a spike arrangement that comprises a holding element (12) introducible into an embedding opening of a running surface (10), in particular of a tire, which element forms a receptacle (14) for an anti-skid stud (16) projecting from the running surface (10) of the tire. According to the present invention, the holding element (12) is made at least in part of magnesium or a magnesium alloy. A method for manufacturing a spike arrangement of this kind is furthermore indicated.

The invention relates to a spike arrangement that comprises a holding element introducible into an embedding opening of a running surface, in particular of a tire, which element forms a receptacle for an anti-skid stud projecting from the running surface of the tire.

The invention further relates to a method for manufacturing a spike arrangement of this kind.

Anti-skid studs of this kind, also called “spikes,” are known from the existing art for improving the adhesion of tires on a roadway that is slick with snow or ice. All known spike arrangements have in common the fact that during operation, for example in particular in the context of a steering or braking operation, a wear-resistant part of the anti-skid stud penetrates into the snow or ice and thereby considerably increases the engagement of the tire with the substrate, and thus the energy that can be transferred.

In addition, all spike arrangements comprise holding elements or holding regions, which are usually embodied in the form of flanges, with which the anti-skid stud is held in the rubber of the tire.

Anti-skid studs of this kind are moreover also used on shoes, horseshoes, snow chains, and other devices that protect, or are to be protected, against a risk of slippage.

For installation of the spike arrangement, the latter is press-fitted into an embedding opening in the running surface of the tire. The flange is surrounded and retained by the elastic tire material.

The wear-resistant part and the holding region can be produced from a single piece. Alternatively, at least two-part systems can be used in which a wear-resistant stud made of hard material, usually a carbide metal stud, is inserted into a recess of a holding element. Connection between the stud and holding element is accomplished by soldering, adhesive bonding, or press-fitting. The holding element can be produced from a readily machined material having favorable material properties, such as steel or sintered iron.

With the known spike arrangements, it is disadvantageous that because of the large centrifugal forces transferred onto the road due to the rotation of the tire, the road surface is highly stressed and thereby damaged. Such damage to the road surface is also intensified in particular by the fact that the anti-skid studs protrude in relatively rigid fashion out of the contact surface of the tire.

A holding element produced from steel is conventionally manufactured in a cold extrusion operation or by forging. Only simple shapes can thereby be created.

It is thus an object of the invention to describe a spike arrangement that is considerably less stressful on roads as compared with the conventional spike arrangements. A further intention is also to describe a particularly simple manufacturing method for a spike arrangement of this kind.

This object of the invention is achieved in terms of apparatus by a spike arrangement in accordance with the features of claim 1, and in terms of method by a manufacturing method in accordance with the features of claim 11. Advantageous refinements are described respectively in the dependent claims.

In accordance therewith, the holding element is made at least in part of magnesium or a magnesium alloy, and can form the receptacle for the anti-skid stud. Magnesium is a strong lightweight metal that is approximately one-third lighter even than aluminum.

Because holding elements produced from magnesium or a magnesium alloy have a much lower weight, including in particular as compared with conventional holding elements made of steel, the centrifugal forces upon rotation of the tires are greatly reduced, thereby enabling operation that is less stressful to a road surface.

In addition, the weight of a tire fitted with the spike arrangements according to the present invention is also much lower as compared with a tire equipped with spikes made of steel, which can ultimately also result in lower fuel consumption.

When it is required that the total weight of the tire when using holding elements produced from magnesium or a magnesium alloy is to remain the same with respect to conventional spikes made of steel, it is then possible to produce more complex geometries from magnesium and a magnesium alloy for the same total weight, which in turn can offer improved grip on snow and ice.

In particular, larger component shapes can be implemented for the same weight. With the use of the magnesium material it is also possible in particular to configure geometries that enable improved lateral guidance and/or improved acceleration behavior or braking behavior. It is furthermore possible to achieve optimized system wear on the entire spike arrangement. The individual wear values for the anti-skid stud, the holding part, and the tire can be coordinated with one another in such a way that uniform abrasion becomes possible. Tire balancing is maintained, however, if abrasion occurs uniformly over all the spike arrangements of a tire.

To ensure secure retention of the anti-skid stud in the holding element and thus on the tire, provision can be made for the anti-skid stud to be held positively in the receptacle of the holding element. Positive anchoring reliably prevents loss of the anti-skid stud. This positive connection is particularly easy to establish in terms of production engineering if provision is made that the anti-skid stud comprises at least one undercut that is held by a casing of the holding element, which casing surrounds the receptacle.

Shifting of the anti-skid stud in its extension direction is also thereby effectively prevented. An undercut of this kind can serve, on the anti-skid stud, as a secure anchor inside the receptacle of the holding element.

Provision can also be made according to the present invention that the holding element locally comprises an overmolded element made of plastic.

The overmolded element made of plastic offers the capability of easily implementing a plurality of conformations, and integrating further functions into the holding element. In addition, the holding elements manufactured in this fashion are particularly lightweight and can also be economically embodied in wear-optimized fashion.

A preferred variant of the invention is such that the anti-skid stud is held pivotably in the receptacle. A result that can be achieved with a pivot mount or floating mount system of this kind is that the anti-skid stud can pivot slightly depending on the condition of the road surface, thus making possible operation with low stress on the road surface and also optimum grip on ice and snow.

In an embodiment of the invention, the anti-skid stud can comprise a substantially cylindrical base element at whose end, extending into the receptacle, an approximately spherical enlargement is shaped on integrally with the base element, the undercut being embodied at the transition from the spherical enlargement to the base element.

Particularly secure anchoring of the anti-skid stud in the holding part is realized with this conformation.

In particularly advantageous fashion, the anti-skid stud can be mounted, pivotably around the spherical enlargement, inside the receptacle of the holding element.

Particularly wide pivoting of the anti-skid stud can be achieved by the fact that the anti-skid stud is at least locally spaced away from the inner wall of the receptacle.

Secure retention of the holding element on the tire can be achieved by the fact that a projecting anchoring foot that can be fixedly anchored in the tire is configured at that end of the holding element which can be introduced into the running surface of the tire.

In accordance with the method according to the present invention, the spike arrangement according to the present invention can be manufactured as follows: An anti-skid stud is manufactured from a hard material, for example from carbide metal. This anti-skid stud is introduced as an insert into an injection mold in which the anti-skid stud has magnesium or a magnesium alloy cast around it. This manufacturing method is notable for particularly simple handling.

The holding element can be manufactured as a die-cast part from magnesium or a magnesium alloy. Undercuts on the holding element can likewise be produced by die-casting.

Alternatively, the holding element can be manufactured from magnesium or a magnesium alloy using the thixo-casting method. This method, also known as “thixoforming” or “thixomolding,” combines the advantages of casting and forging. The magnesium, or alloy, to be processed is heated to the transition temperature between solid and liquid, and processed using an injection-molding method. The viscosity of the material decreases in the thixotropic state. The metal, resembling modeling clay, can thus be forced very precisely into molds with little pressure. The cycle time, material use, and flow paths for thixo-casting are reduced as compared with die-casting, and component quality and properties are improved. The fabricated parts are notable for reduced contraction along with greater toughness. Although comparable properties can be obtained by forging, only comparatively rough shapes can be manufactured thereby.

One conceivable variant of the invention is such that a plastic injection-molded part is molded or attached onto the holding element.

The invention will be further explained below with reference to an exemplifying embodiment depicted in the drawing.

The single FIGURE is a schematic, sectioned side view of a spike arrangement that comprises a holding element 12 introduced into an embedding opening of a running surface 10 of a tire and anchored there. A projecting anchoring foot 30 is embodied for this purpose at that end 28 of holding element 12 which can be introduced into running surface 10 of the tire.

Holding element 12 forms a receptacle 14 for an anti-skid stud 16 projecting from running surface 10 of the tire.

Anti-skid stud 16 is made of a hard material, for example carbide metal, and comprises a substantially cylindrical base element 22 at whose end 24, extending into receptacle 14, an approximately spherical enlargement 26 is shaped on integrally with base element 22.

Embodied at the transition from spherical enlargement 26 to base element 22 is an undercut 18 which is surrounded by overmolded element 20, made of a magnesium alloy, that forms holding part 12.

Anti-skid stud 16 is mounted inside receptacle 14 of holding element 12 pivotably around spherical enlargement 26 in the directions of double arrow S, anti-skid stud 16 being spaced away from the inner wall of receptacle 14.

The spike arrangement shown is manufactured by shaping holding part 12, as a die-cast part, from magnesium or a magnesium alloy. In this context, anti-skid stud 16 is introduced as an insert into an injection mold (not shown) and overmolded with magnesium or a magnesium alloy using the thixo-casting method, in order to constitute holding part 12.

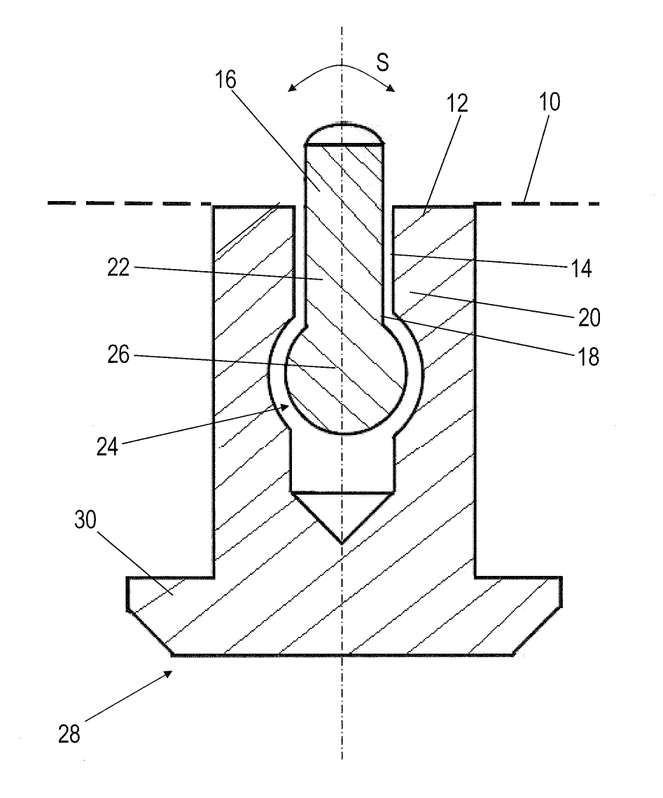

Using the method described, in addition to the conformation shown in FIG. 1 it is possible to generate almost any desired shapes from magnesium, with particularly high quality and dimensional stability and particularly good dimensional accuracy.

1. A spike arrangement comprising:
a holding element introducible into an embedding opening of a running surface of a tire, which element forms a receptacle, the holding element being made at least in part of magnesium or a magnesium alloy; and
an anti-skid stud received in the receptacle.

2. The arrangement according to claim 1, wherein the anti-skid stud is held positively in the receptacle of the holding element.

3. The arrangement according to claim 2, wherein the anti-skid stud comprises at least one undercut that is held by a casing of the holding element, which casing surrounds the receptacle.

4. The spike arrangement according to claim 1, wherein the holding element locally comprises an overmolded element made of plastic.

5. The spike arrangement according to claim 1, wherein the anti-skid stud is held pivotably in the receptacle.

6. The spike arrangement according to claim 5, wherein a pivot mount is formed by the anti-skid stud and the receptacle.

7. The arrangement according to claim 3, wherein the anti-skid stud comprises a substantially cylindrical base element at whose end, extending into the receptacle, an approximately spherical enlargement is shaped on integrally with the base element, the undercut being embodied at the transition from the spherical enlargement to the base element.

8. The arrangement according to claim 7, wherein the anti-skid stud is mounted, pivotably around the spherical enlargement, inside the receptacle of the holding element.

9. The arrangement according to claim 1, wherein the anti-skid stud is at least locally spaced away from an inner wall of the receptacle.

10. The arrangement according to claim 1, wherein a projecting anchoring foot is configured at an end of the holding element which can be introduced into the running surface of the tire.

11. A method for manufacturing a spike arrangement that comprises a holding element, introducible into an embedding opening of a running surface of a tire, which element comprises a receptacle for an anti-skid stud, the method comprising the following steps:
manufacturing an anti-skid stud from hard material;
introducing the anti-skid stud into a molding tool;
casting magnesium or a magnesium alloy around the anti-skid stud in order to form the holding element.

12. The method according to claim 11, wherein the holding element is manufactured as a die-cast part from magnesium or a magnesium alloy.

13. The method according to claim 11, wherein the holding element is manufactured from magnesium or a magnesium alloy using the thixo-casting method.

14. The method according to claim 11, wherein a plastic injection-molded part is molded or attached onto the holding element.
